(19) United States
(12) Patent Application Publication
(10) Pub. No.: US 2002/0019973 A1
(43) Pub. Date: Feb. 14, 2002

(54) Compiler and method for compiling easily adaptable to processor specifications

(75) Inventor: Seiji Hayashida, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Minato-ku (JP)

(21) Appl. No.: 09/902,133

(22) Filed: Jul. 11, 2001

(30) Foreign Application Priority Data
Jul. 11, 2000 (JP) P2000-210412

(51) Int. Cl. G06F 9/44

(52) U.S. Cl. 717/106

(57) ABSTRACT

In a compiler, accommodation to processor specifications is facilitated by customizing by defining an intrinsics function from outside. This compiler has a character string analyzer which divides instructions coded within a source program into tokens, a syntax analyzer which analyzes the syntax of the tokens to determine whether this syntax is correct, a code generator which converts the source program to machine language, and an intrinsics (build-in) function information database into which is stored built-in function definition attributes. The syntax analyzer analyzes the intrinsics function definition and instruction attributes, performs storage into an intrinsics function information database, and develops this intrinsics function information to generate object code.

### BACKGROUND OF THE INVENTION

1. Field of the Invention

The present invention relates to a compiler and method for compiling, which are easily adaptable to specifications of a processor, and more particularly to technology related to a compiler for compiling a high-level language such as C language into machine language, in which built-in (intrinsics) function can be arbitrarily defined and added from outside the compiler, so as to enable generation of a program that accommodates processor specification expansion and the like.

2. Description of Related Art

Conventionally, even in the case in which a processor had a circuit configuration corresponding to a mov instruction, for example (mov Rn, Rm which moves the contents of register Rm into the register Rn), it was not possible for the programmer to generate a high-level programming language program using the mov instruction unless a compiler accommodates the mov instruction. In such cases, in spite of the fact that the architecture of the processor being used by the programmer accommodates the mov instruction, the it is not possibly to simply code “mov Rn, Rm”. Instead, in order to achieve the same function it was necessary to code the program so as to use the lw (load word) and sw (store word) instructions. That is, even though the processor itself has a circuit configuration corresponding to the mov instruction, the program must be executed so as to use a plurality of instructions such as lw and sw or the like.

In the case of using a compiler that does not accommodate instructions that cannot be achieved using with a combination of existing instructions, such as a multimedia instruction, in which parallel processing is done of a plurality of data with single instruction, the programmer cannot make use of the characteristic functions of the processor

Therefore, in order to enable efficient use of the processor by the use, the provider of the processor needed to provide a compiler that accommodate the characteristic specifications of the processor (that is, the processor architecture and instruction set) each time there was a change in the specifications of the processor.

Conventionally, a method of having the compiler accommodate the characteristic specifications (processor architecture and instruction set) was that of using intrinsics function, these being function provided beforehand as part of the processing system for the programming language, and being built-in functions provided for the purpose of compiling instruction code of a high-level language characteristic to the target processor into machine language.

At the provider of the processor and the compiler, intrinsics functions were built into the compiler in accordance with the target processor. By doing this, it was possible for the programmer to code instruction operations characteristic to the processor using a high-level language, and to compile these into machine language.

Conventionally, however, because intrinsics function was already built into the compiler, it was not possible for a user to define an original intrinsics function. In a compiler for a processor that does not undergo changes in its specifications, this does not create a problem.

In a compiler, however, in which the user can make expansions of specifications (processor architecture and instruction set), because it is necessary to have a specially dedicated compiler accommodating the user specification expansions (processor architecture and instruction set), although there was a need for the user to make original customization of intrinsics functions, this was not possible in the conventional art.

### SUMMARY OF THE INVENTION

Accordingly, it is an object of the present invention to provide a compiler and method for compiling, which can easily adapt to processor specifications, by enabling customization by the arbitrary addition of definitions of intrinsics function from outside the compiler, either at start-up time or during operation.

A compiler according to an embodiment of the present invention reads in definitions and attributes for such built-in instrinsic functions coded in a source program or in a header file, for example, and converts the source program to machine language in accordance with these definitions and attributes of the built-in intrinsic functions.

An aspect of the present invention is a compiler for generating object code from an input source program, comprising: a character string interpreter which divides instructions coded within an input source program into tokens; a syntax analyzer which analyzes syntax of said tokens, and makes a judgment as to whether or not a definition of an intrinsics function and an instruction attribute information characterizing an instruction coded in intrinsics functions is included in a combination of said tokens; an intrinsics function information database into which a definition of said intrinsics function and said instruction attribute information are stored as intrinsics function information; and a code generator which develops an instruction that calls an intrinsics function within said source program by referring to said intrinsics function information, and which converts said developed source program either to machine language or to an intermediate code.

Another aspect of the present invention is a compiler for generating object code from an input source code program, comprising: a character string interpreter which divides instructions coded within an input source program into tokens; a syntax analyzer, which analyzes syntax of said tokens; an intrinsics function information database into which a definition of an intrinsics function and instruction attribute information characterizing an instruction coded by the intrinsics function are stored as intrinsics function information; and a code generator which develops an instruction that calls an intrinsics function within said source program by referring to said intrinsics function information, and which converts said developed program either to machine language or to an intermediate code.

Another aspect of the present invention is a compiler for generating object code from an input source program, comprising: a character string interpreter which divides instructions coded within an input source program into tokens; a syntax analyzer which analyzes syntax of said tokens; an intrinsics function information database into which a definition of an intrinsics function and instruction attribute information characterizing an instruction coded by the intrinsics function are stored as intrinsics function information; and a code generator which develops an instruction that calls an intrinsics function within said source program by referring to said intrinsics function information, and which converts said expanded source program either to machine language or to intermediate code, wherein said intrinsics function information includes a function declaration statement, to which is added a prescribed identifier indicating an intrinsics function, dummy argument information, and said instruction attribute information.

Another aspect of the present inventions is a method for compiling which generates object code from an input source program, comprising: storing a definition of an intrinsics function into an intrinsics function information database; storing instruction attribute information characterizing an instruction coded by an intrinsics function into said intrinsics function information database; dividing instructions coded within an input source program into tokens; analyzing the tokens and detecting from a combination of said tokens a declaration of a start of coding with regard to said intrinsics function; and developing an instruction that calls an intrinsics function within said source program by referring to said intrinsics function information database, and converting said developed source program either to machine language or to intermediate code.

Another aspect of the present invention is a method for compiling, which generates object code from an input source program, comprising: dividing instructions coded within an input source program into tokens; analyzing said tokens and detecting from a combination of said tokens a declaration of a start of coding with regard to said intrinsics function; accessing an intrinsics function information database, into which are stored a definition of an intrinsics function and instruction attribute information characterizing an instruction coded by said intrinsics function, developing to an instruction that calls an intrinsics function within said source program, and converting said expanded source program either to machine language or to intermediate code.

Another aspect of the present invention is a computer-readable recording medium onto which is stored a program causing a computer to execute compiling processing that generates object code from an input source program, said program comprising: processing for character string interpretation, so as to divide instructions coded within an input source program into tokens; processing for analyzing said tokens and for analyzing a syntax thereof to judge whether or not a combination of said tokens has a definition of an intrinsics function and instruction attribute information characterizing an instruction coded by said intrinsics function; processing for storing a definition of said intrinsics function and said instruction attribute information as intrinsics function information; and processing for developing an instruction that calls said intrinsics function within said source program by referring to said intrinsics function information, and generating code that converts said expanded source program either to machine language or to intermediate code.

Another aspect of the present invention is a computer-readable recording medium onto which is stored a program causing a computer to execute compiling processing that generates object code from an input source program, the program comprising: processing for character string interpretation, so as to divide instructions coded within an input source program into tokens; processing for analyzing syntax, so as to analyze the tokens; processing for storing a definition of an intrinsics function and instruction attribute information characterizing an instruction coded by said intrinsics function as intrinsics function information; and processing for developing an instruction that calls an intrinsics function within said source program by referring to said intrinsics function information, and generating code that converts said developed source program either to machine language or to intermediate code.

Another aspect of the present invention is a computer-readable recording medium onto which is stored a program causing a computer to execute compiling processing that generates object code from an input source program, said program comprising: processing for character string interpretation, so as to divide instructions coded within an input program into tokens; processing for analyzing syntax, so as to analyze said tokens; processing for storing a definition of an intrinsics function and instruction attribute information characterizing an instruction coded by said intrinsics function as intrinsics function information; processing for accessing said intrinsics function information; processing for developing an instruction that calls an intrinsics function within said source program by referring to said intrinsics function information; and processing for generating code that converts the thus developed source program either to machine language or to intermediate code, wherein said intrinsics function information comprises a function declaration statement to which is added a prescribed identifier indicating an intrinsics function, dummy argument information, and said instruction attribute information.

Another aspect of the present invention is a program for causing a computer to execute compiling processing that generates object code from an input source program, said program comprising: processing for character string interpretation so as to divide instructions coded within an input source program into tokens; processing for analyzing said tokens, and performing syntax analysis so as to judge whether or not a combination of the tokens has an intrinsics function definition and a definition of instruction attribute information characterizing an instruction coded by said intrinsics function; processing for storing said intrinsics function definition and intrinsics function information as intrinsics function information; processing for developing an instruction that calls an intrinsics function within said source program by referring to said intrinsics function information; and processing for generating code that converts said developed source program either to machine language or to intermediate code.

Another aspect of the present invention is a program for causing a computer to execute compiling processing that generates object code from an input source program, said program comprising: processing for character string interpretation so as to divide instructions coded within an input source program into tokens; processing for analyzing the syntax of said tokens; processing for storing an intrinsics function definition and attribute information characterizing an instruction coded by said intrinsics function as intrinsics function information; processing for accessing said intrinsics function information; processing for developing an instruction that calls an intrinsics function within said source program by referring to said intrinsics function information; and processing for generating code that converts said developed source program either to machine language or to intermediate code.

Yet another aspect of the present invention is a program for causing a computer to execute compiling processing that generates object code from an input source program, said program comprising: processing for character string interpretation so as to divide instructions coded within a source program into tokens; processing for analyzing the syntax of said tokens; processing for storing an intrinsics function definition and attribute information characterizing an instruction coded by said intrinsics function as intrinsics function information; processing for accessing said intrinsics function information; processing for developing an instruction that calls an intrinsics function within said source program by referring to said intrinsics function information; and processing for generating code that converts said developed source program either to machine language or to intermediate code, wherein said intrinsics function information is made up of a function declaration statement to which is added a prescribed identifier indicating an intrinsics function, dummy argument information, and said instruction attribute information.

Other features and advantages of the present invention will become apparent from the following description, taken in conjunction with the accompanying drawings.

### BRIEF DESCRIPTION OF THE DRAWING

The accompanying drawings, which are incorporated in and constitute a part of the specification, illustrate presently preferred embodiments of the invention and, together with the general description given above and the detailed description of the preferred embodiments given below, serve to describe the principles of the invention. Of these drawings:

FIG. 1 is a block diagram showing the configuration of an intermediate code generation type of compiler according to the first to third embodiments of the present invention;

FIG. 2 is a block diagram showing the configuration of an intermediate code non-generating type of compiler according to the first to third embodiments of the present invention;

FIG. 3 is a flowchart showing the flow of intrinsics function definition processing in a compiler and method for compiling according to the first embodiment of the present invention;

FIG. 4 is a flowchart showing the flow of attribute information processing in the first embodiment of the present invention;

FIG. 5 is a flowchart showing the flow of processing for the case in which an intrinsics function is used in the third embodiment of the present invention; and

FIG. 6 is a simplified drawing showing the flow of processing for the case in which intrinsics function information is in a different file in a compiler according to the third embodiment of the present invention.

### DETAILED DESCRIPTION OF THE INVENTION

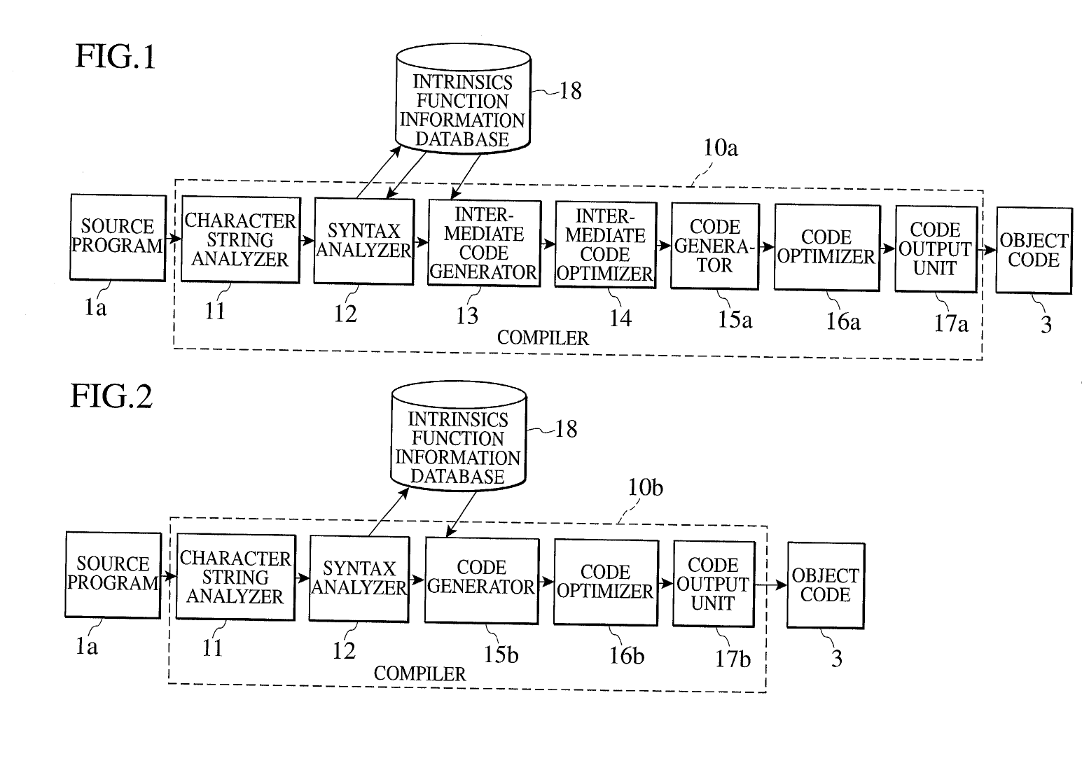

Embodiments of the present invention, a compiler and method for compiling easily adaptable to processor specifications, are described in detail below, with references made to accompanying drawings FIG. 1 through FIG. 6. In the descriptions of the accompanying drawings given below, common elements or similar elements between drawings are assigned the same or a similar reference numeral.

First Embodiment

The first embodiment of a compiler and method for compiling is described below, with references being made to FIG. 1 through FIG. 5. The first embodiment of the present invention provides a function that enables setting of information required in the operation of an intrinsics function from outside the compiler.

In the example of the first embodiment of the present invention described below, the mov Rn, Rm instruction (which substitutes the content of the register Rm into the register Rn) is defined as an intrinsics function. The description that follows presents the method of definition, the method of use, and the method of implementing the compiler.

(1) Method of Defining the Intrinsics Function

An intrinsics function is defined using unique reserved words (_asm, _reg_dest, _reg_src) and #pragma custom. The definition of move Rn, Tm is coded as follows.

void _asm mov (int _reg_dest, int _reg_src);

This method of definition, with the exception of the addition the original keyword _asm, conforms to the function declaration in the ISO/JIS C language standard (ISO/IEC9899: 1990). The _asm functions as a declaration and identifier for an intrinsics function. Thus the addition of this _asm indicates that this is not a conventional function declaration, but rather an intrinsics function definition.

The function name mov indicates that this is the definition of an intrinsics function for the instruction mov.

Because the _reg₁₃ dest and _reg_src are identifier names for dummy arguments, it is possible, in accordance with the ISO/JIS C language standard, to code them as arbitrary identifier names. The dummy arguments are used in the definition of the function, and these are replaced by actual arguments when the function is called. When defining an intrinsics function, by using these special reserved words, information with regard to the operation of the mov instruction is transmitted to the compiler. The _reg_dest is the register destination operand, and _reg_src is the register source operand. Although in the first embodiment, _asm, _reg_dest, and _reg_src are specifically used as reserved words, and word or phrase other than those reserved in the ISO/JIS C language standard can be used as an intrinsics function defining reserved word.

Next, #pragma custom for the case of the mov instruction is as follows.

#pragma custom mov 2byte

The above-noted #pragma custom is a pre-processing instruction defined in the ISO/JIS C language standard, and enables custom expansion, depending upon the processing system. The custom is a keyword indicating customization of an intrinsics function.

In the first embodiment, various attributes of the intrinsics function are defined by using #pragma custom. In this description, the instruction length of the mov instruction is defined as being 2 bytes. Although the word “custom” is used in this first embodiment, it will be understood that this can be replaced by any arbitrary word or phrase.

The above-noted definition can also be made in a header file, rather than in the source program.

(2) Method of Using the Intrinsics Function

Before actually using an intrinsics function, the intrinsics function is defined by a C language program such as presented below. The intrinsics function is used in the coding method that calls a function conventionally.

<C Language Program>

/*Define an intrinsics function*/

void _asm mov(int _reg_dest, int _reg_src);

#pragma custom mov 2byte void test0{

int a, b;

/*Using the intrinsics function*/

mov(a,b);

}

The compiler performs compiling in accordance with the defined content of the intrinsics function which has been pre-defined, thereby creating an assembler file such as shown below. The mov instruction is generated as specified.

<Generated assembler file>

_test:

mov $1,$0

ret

(3) Implementing an intrinsics function

FIG. 1 and FIG. 2 shows the flow of compiler processing. The compiler is a software program, which upon inputting a source program coded in a high-level language, outputs object code.

FIG. 1 is a drawing showing the of a intermediate code generation type of compiler. As shown in FIG. 1, a compiler according to the first embodiment comprises a character string interpreter 11, a syntax analyzer 12, an intermediate code generator 13, an intermediate code optimizer 14, a code generator 15a, a code optimizer 16a, a code output unit 17a, and an intrinsics function information database 18.

The compiler 10a first performs character string interpretation by using the character string interpreter 11. The character string interpreter 11 performs processing so as to divide instructions coded in the source program 1 into minimum units called tokens.

Next, the syntax analyzer 12 performs syntax analysis. At the syntax analyzer 12, instructions that have been divided into tokens, which are minimum units having meanings such as variables, symbols, and the like, divided by the immediately previous character string interpreter 11, performs a check of syntax to see whether these are syntactically suitable as defined by each particular language.

Then, after intermediate code generation by the intermediate code generator 13, and intermediate code optimization by the intermediate code optimizer 14, code is generated by the code generator 15a. At the code generator 15a, in response to division of the source program 1 into minimum units and the results of a check for syntax errors, a code generation function is used to perform processing that converts the source program 1 to an assembler format or binary format machine language.

Additionally, code optimization is performed by the code optimizer 16a. At the “code optimization” stage, the machine language resulting from the conversion performed by the immediately upstream code generator 15a is modified so as to improve the efficiency of actual processing.

The code output unit 17a then outputs object code 3.

The reason that the compiler 10a generates intermediate code is that, if code is generated immediately after a syntax analysis, there are cases in which the size of the generated program would be very large and conversion processing cannot be performed efficiently. For this reason, conversion is first done to intermediate code equivalent to the source program 1a and in a simple language, before translation processing is performed. It will be understood, however, that object code would result even if the generation of intermediate code and the intermediate code optimization were to be omitted.

The intrinsics function information database 18 stores in it the above-noted intrinsics function definition information and attribute information.

FIG. 2 is a drawing showing the configuration of a type of compiler which does not generate intermediate code. As shown in FIG. 2, a compiler 10b generates object code 3 from a source program 1a via a character string interpreter 11, a syntax analyzer 12, a code generator 15b, a code optimizer 16b, and finally a code output unit 17b.

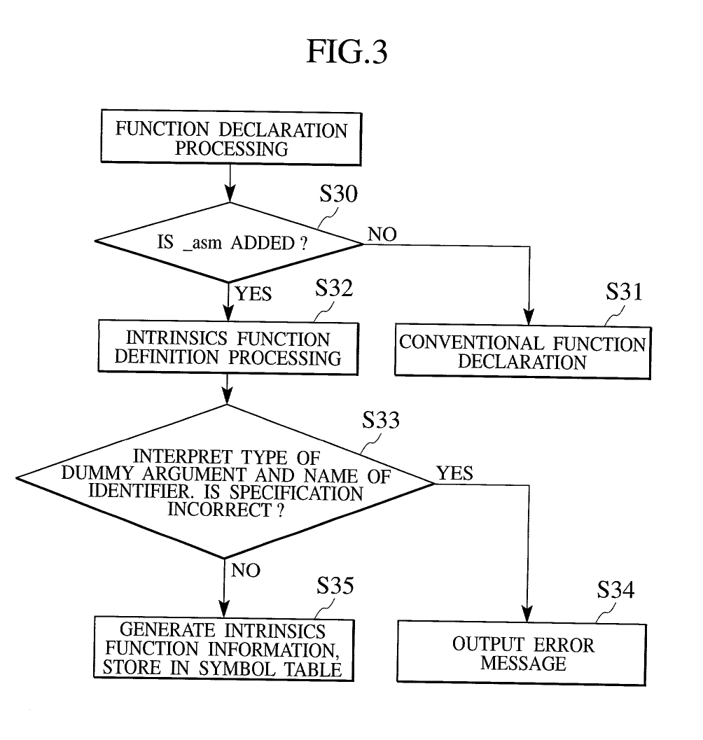

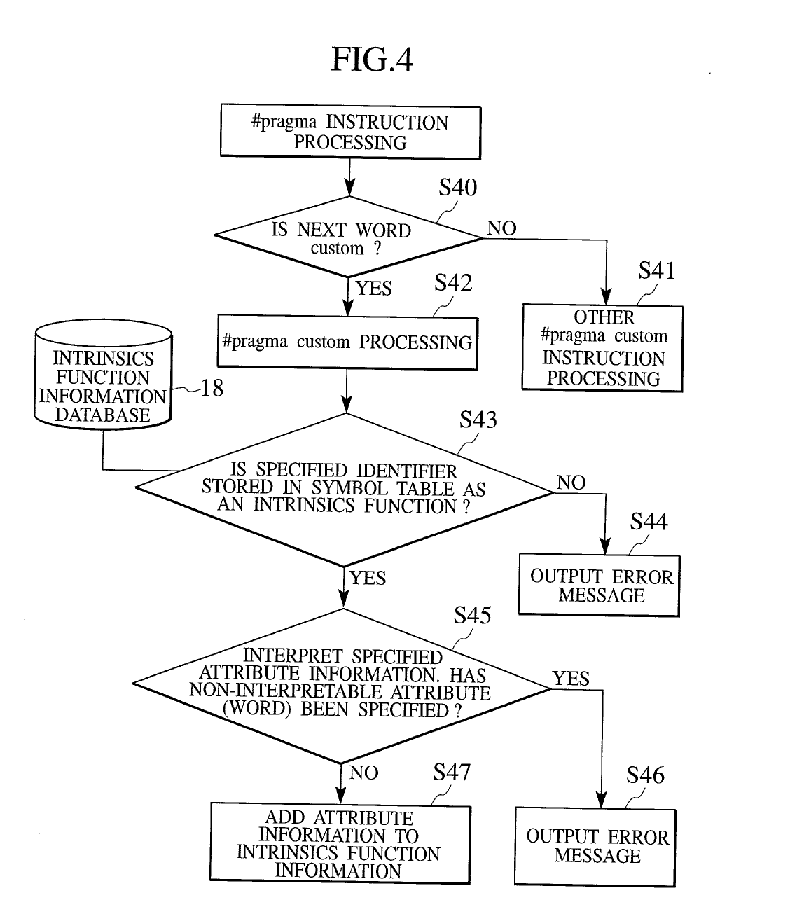

In either of the compilers shown in FIG. 1 and FIG. 2, it is necessary to identify the definition and use of an intrinsics function in the syntax analyzer 12. FIG. 3 shows the flow of processing for identifying the intrinsics function, and FIG. 4 shows the flow of attribute information processing.

FIG. 3 is a drawing showing the flow of syntax analysis of an intrinsics function definition using the syntax analyzer 12. First, as shown in FIG. 3, a check is made to determine whether or not “_asm” has been added (step S30). If “_asm” has not been added, the judgment is made that this is a declaration of a conventional function (step S31). In the case in which “_asm” has been added, intrinsics function definition processing is performed (step S32). First, interpretation is performed of the type information for the dummy arguments, and the name of the identifier (step S33). If there is an error discovered in the method of specifying the type of the dummy arguments, an error message is output (step S34). In the case in which there is no error in the method of specifying the type of the dummy arguments, the details of the intrinsics function definition are recorded in a symbol table (step S35), which is a table used for searching for defined intrinsics functions and their arguments.

FIG. 4 is a drawing showing the flow of attribute information processing by the intermediate code generator 13 of FIG. 1 and the syntax analyzer 12 of FIG. 2. As shown in FIG. 4, a check is made to determine whether the word “custom” follows immediately after “#pragma” (step S40). In the case in which this is not “custom”, other #pragma instruction processing is performed (step S41). In the case of “custom”, however, “#pragma custom” processing is performed (step S42). A check is performed to determine whether or not the specified identifier (for example, mov) is stored in the symbol table as an intrinsics function in the intrinsics information database 18 (step S43). In the case in which this identifier is not stored, an error message is output (step S44). In the case in which this identifier is stored in the symbol table as an intrinsics function, interpretation of the specified attribute information is performed (step S45). In the case in which the specified attribute information cannot be interpreted, an error message is output (step S46). In the case in which a specified attribute (phrase, such as 2byte) can be interpreted, attribute information is added to the intrinsics function information (step S47).

In this embodiment of the present invention, the term attribute is used to refer to an attribute for characterizing an instruction so as to adapt it to processor specifications. For example, this could indicate how many bytes of code an instruction is, that an instruction is an instruction for calling function, that an instruction is a conditional branching instruction, or what register an instruction is dependent upon, and the like.

In the first embodiment, if “_asm” has been added, intrinsics function definition processing begins and, if there is no error found in the type information of the dummy argument or the identifier name, storage is done into a symbol table of the intrinsics function information database 18 as intrinsics function information. If the word following “#pragma” is “custom”, “#pragma custom” processing begins and, if the specified identifier had been store in the symbol table, the specified information (for example, 2byte) is stored in the intrinsics function information database 18 as attribute information. By doing this, it is possible to define an intrinsics function when the compiler is started up or while it is operating.

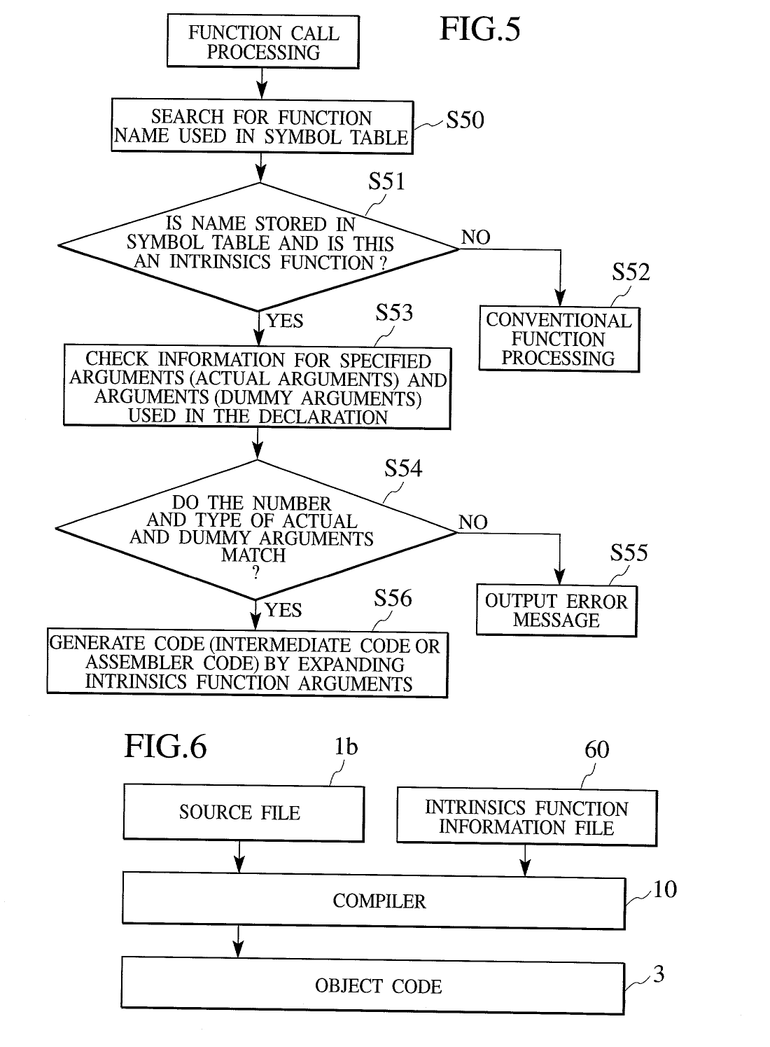

FIG. 5 is a drawing showing the compiler flow for the case of using an intrinsics function. As shown in FIG. 5, when function calling processing is started, the first thing that is done is that a search is made in the symbol table for the name of the function being used (step S50). Then, a check is made to determine whether or not the name is stored in the symbol table and whether or not the function is the intrinsics function (step S51). In the case in which the function name is stored in the symbol table, but the function is not an intrinsics function, conventional function processing is performed (step S52). In the case in which the name is a name of an intrinsics function stored in the symbol table, a check is made of information of the specified arguments (actual arguments) and the arguments (dummy arguments) used when the intrinsics function was declared (step S53). Additionally, a check is performed for agreement with regard to the number and type of dummy and actual arguments. If the number and type of arguments do not agree, an error message is output (step S55). If the number and type of arguments agree, code (intermediate code or assembler code) is generated as the intrinsics function (step S56).

By the above-noted series of processing steps, it is possible to perform compilation using a user-defined intrinsics function.

According to the first embodiment of the present invention, the definition and attributes of an intrinsics function within a source program are analyzed and stored into a storage means, thereby enabling arbitrary additional definition of an intrinsics function at the time of launching the compiler or during operation thereof.

By customizing an intrinsics function, it is possible to easily adapt the compiler to expansions and changes in the specifications of a processor.

Second Embodiment

In contrast to the first embodiment, which was described above for the example in which the mov instruction was implemented. a second embodiment of the present invention provides a compiler enabling easy implementation of an instruction other than the mov instruction. Universal intrinsics function definition and use are described below with regard to this second embodiment.

(1) Reserved words used for dummy argument identifier

In the second embodiment, by adding “_reg_src” and “_reg_dest”, original reserved words “_reg_modify”, “_mem_read”, “_mem_write”, “_mem_modify”, “_imm”, and “_label”, other than the reserved words “_reg_src” and “_reg_dest” in the first embodiment, it enables the coding of typical machine language instructions using an intrinsics function.

“_reg_modify” indicates a register operand that is both a source and a destination. “_mem_read” is a memory read operand. “_mem_write” is a memory write operand. “_mem_modify” indicates a memory read operand and a memory write operand for the results of a calculation. “_imm” indicates an immediate operand. “_label” indicates an operand that specifies a label name for a branching destination.

(2) Attributes that can be specified with #pragma custom

By defining the attributes of “read”, “write”, “modify”, “interlock”, “freeze”, “unconditional”, “call”, and “return” separate from the attribute of “mov” (2byte) indicated in the first embodiment, it is possible to code typical machine language instructions. “read”, in addition to the operand specified by the intrinsics function definition, specifies an operand used as a source. “write”, in addition to an operand specified by the intrinsics function definition, specifies an operand used as a destination. “modify”, in addition to an operand specified by the intrinsics function definition, specifies an operand used as a source and a destination.

For example, in the specifications for the mul instruction of the Toshiba TX39 microprocessor, the mul instruction has, in addition to a specified operand, a low register ($lo) as a destination. In this case, the definition is made as “#pragma custom mul write $lo”.

By making the “read”, “write”, and “modify” specifications, it is possible to set all information for all resources used by an intrinsics function, and it is possible for the compiler to generate the machine language instructions.

“interlock” indicates the need for instruction scheduling in the compiler. In a case in which a pipeline is stalled because adjacent instructions (for example, instruction A and instruction B) use a common operand, an instruction that does not use the operand that is causing the stalling (for example, instruction C) is inserted between the adjacent instructions (for example, instruction A and instruction B), thereby preventing the stalling.

“freeze” indicates that the sequence of instructions before and after the intrinsics function is not to be changed.

If “_label” is specified as an operand, it is not possible to distinguish whether the instruction is a conditional branching instruction or a unconditional branching instruction. For this reason, conditional branching is made the default, and “unconditional” is specified as an attribute in the case of an unconditional branching instruction. If the unconditional is set as the default, “conditional” is specified as an attribute for a conditional branching instruction.

“return” is used in a case in which a returning instruction from a function call is defined as an intrinsics function.

(3) A method for defining a coprocessor instruction is as follows.

The C language program is coded as follows.

void _asm cpmov (int _cop_dest,int _cop_src);

#pragma custom cpmov cop 2byte

In order to indicate that this is a coprocessor instruction, “cop” is added to an attribute of “#pragma custom”. This indicates that the specified function (for example “cpmov”) is a coprocessor instruction.

Additionally, “_cop_src”, “_cop_dest”, and “_cop_modify” are added as reserved words used in dummy argument identifiers. “cop src” indicates a coprocessor register source operand. “_cop_dest” indicates a coprocessor register destination operand. “_cop_modify” indicates an operand is both a coprocessor register source operand and a coprocessor register destination operand.

(4) A method for setting the scheduling attributes for an intrinsics function of a compiler for a VLIW (very long instruction word) or super scalar type processor is as follows. In a VLIW or super scalar processor there is a limitation imposed on the instructions that can be simultaneously performed. For this reason, it is necessary to set for each instruction what arithmetic unit it can be executed by. This information is set as an attribute of #pragma custom, thereby enabling accommodation of VLIW and super scalar processors.

In order to generate optimal machine language instructions for a VLIW or super scalar processor, it is necessary to set a characteristic attribute for these processors. This attribute is the type of instruction that can executed by each execution unit.

With many VLIW and super scalar processors, there is a limitation on the instructions that can be executed by each execution unit. For this reason, it is necessary to set for each intrinsics function which execution units can perform execution. The set attribute is used in the code optimization of machine language instructions, resulting in generation of optimized machine language instructions.

For example, with two execution units, if the names of the execution units are P0 and P1, P0 and P1 are set as attributes.

To take an example in the case in which execution by the P0 and P1 execution units is possible in the case of the mov instruction, but the add instruction can be executed only by the P0 execution unit, the coding is done as follows.

void _asm mov (int _reg_dest, int _reg_src);

#pragma custom mov p0 p1

void _asm add (int _reg_modify, int _reg_src);

#pragma custom add p0

(5) In the case in which the first argument of an intrinsics function is “_reg_dest” or “_cop_dest”, setting is possible as the value returned by the function. When this is done, if a second argument exists, there is one rolling forward of the second argument. For example,

void _asm mov(int _reg_dest, int _reg_src); is the same as

int _asm mov(int _reg_src);

In this case, the destination for the substitution can be specified using “=”, this becoming similar to C language, making the code more readable, and making it easier for the programmer to code the source program.

A program having content similar to that of the first embodiment is coded as follows.

int _asm mov(int _reg_src);

#pragma custom mov 2byte

void test&Ovalhollow;{

int a,b;

a=mov(b);

}

According to the second embodiment, an intrinsics function of a VLIW or super scalar type processor can be defined at the time of launching of the compiler or during operation thereof.

Also, the use of the operator “=” for specifying the destination for a substitution operation makes the code look like C language, making it more readable.

Additionally, (1) by being able to accommodate both the case in which a given instruction (for example, the mov instruction) is implemented as a conventional instruction and the case in which implementation is done as an intrinsics function in machine language, it is possible to make the “intrinsics function arguments and type of returned value” the same as the “conventional function arguments and type of returned value”, and (2) by using conditional compiling of the compiler and making use of a command line option specified at launch time to specify definition as either an intrinsics function or a conventional function, it is possible for a programmer to code a source program without needing to be concerned with whether a function is to be implemented as an intrinsics function or as a conventional function.

The term “conditional compiler” used above is provided in the C compiler as #ifdef, #else, and #endif, and a command line option defined as a macro specified at the time of compiler launching enables a change in the contents to be compiled.

An example of conditional compiling is shown below. In the code given below, the code of (5) above is assumed.

#ifdef _USE_MOV /*Processing for the case in which the macro _USE_MOV is defined*/

/*Intrinsics function*/

int _asm mov(int _reg_src);

#pragma custom mov 2byte

#else /*Processing for the case in which the macro _USE_MOV is not defined*/

/*Conventional function*/

int mov(int src); /*This function performs the same processing as the mov instruction*/

#endif

/*Actual processing*/

void test&Ovalhollow;{

int i,j;

/*Use is possible regardless of whether or not this is an intrinsics function*/

i=mov(j);

}

Third Embodiment

In the first and second embodiment, function definition was done using #pragma custom. In contrast to this, the third embodiment performs definition without using #pragma custom.

In the third embodiment, at step S33 of FIG. 3 described with regard to the first embodiment, the processing of steps S45 through S47 of FIG. 4 is executed.

In the case in which attributes specified by #pragma custom are included in a function definition, additional original reserved words are added. In this case, there is the method of adding a plurality of reserved words and the method of adding a single reserved word.

(1) Method of adding a plurality of reserved words

By adding a reserved word (such as _{—}2byte, _read, _write, _modify, _interlock, _freeze, _uncondition, _call, and _return) for each attribute individually, it is possible to set attributes even without #pragma custom. For example, the mov instruction of the first embodiment can be defined as void _asm_{—}2byte mov(int _reg_dest, int _reg_src);.

(2) Method of adding a single reserved word

It is possible to make a definition by adding a single reserved word, as opposed to adding a reserved word for each attribute individually. In the case of he reserved word “_attr” the mov instruction of the first embodiment can be defined as follows.

void _asm_attr(2byte) mov(int reg dest, int reg src);

In this case, when performing a syntactical analysis of the “_attr”, a check is made of the specified attributes. It is desirable to have only a few reserved words, as the fewer reserved words there are, the less restriction there will be in programming.

Although the descriptions of the first to third embodiments are presented for the case in which information required for intrinsics functions is coded within the source program file, it will be understood that it is alternately possible to have information required by intrinsics functions read in from a separate file. FIG. 6 shows in simplified form the case in which intrinsics function information is contained in a separate file. As shown in FIG. 6, a source file 1b and intrinsics function information file 60 are input to the compiler 10, which produces object code 3.

According to the above-noted configuration, because the intrinsics function is held in a separate file, the restrictions with regard to reserved words, which were imposed by the above-described embodiments, are lifted, so that it is possible to code information required for intrinsics functions in an arbitrary format.

In summary, according to the embodiments of the present invention, by enabling the setting of information required for operation of an intrinsics function from outside the compiler, it is possible to easily expand the compiler, enabling the user to customize the compiler.

By placing the definition of an intrinsics function together within the source program to be compiled, a number of effects are achieved, as follows.

1) Because the definition of an intrinsics function merely takes the form of a conventional function with a number of reserved words added thereto, it is easy for the user to understand.

2) Because provision to the user can be made as a C language header file, software releases are simpler to make.

3) In the case in which the first argument of an intrinsics function is a destination, by changing the function definition, it requires no necessity to change the part that uses a instruction (for example, mov instruction) having the same name as the name of the intrinsics function (for example, mov function).

Additional advantages and modifications of the present invention will readily occur to those skilled in the art. In its broader aspects, the present invention is not limited to the specific details and representative embodiments shown and described above. Accordingly, various modifications may be made to the present invention without departing from the spirit or scope of the general inventive concept as defined by the appended claims and their equivalents.

What is claimed is:

1. A compiler for generating object code from an input source program, comprising:
a character string interpreter which divides instructions coded within an input source program into tokens;
a syntax analyzer which analyzes syntax of said tokens, and makes a judgment as to whether or not a definition of an intrinsics function and an instruction attribute information characterizing an instruction coded in intrinsics functions is included in a combination of said tokens;
an intrinsics function information database into which a definition of said intrinsics function and said instruction attribute information are stored as intrinsics function information; and
a code generator which develops an instruction that calls an intrinsics function within said source program by referring to said intrinsics function information, and which converts said developed source program either to machine language or to an intermediate code.

2. The compiler according to claim 1, wherein said syntax analyzer distinguishes a prescribed identifier that indicates an intrinsics function from among a function declaration part of said source program to judge as to whether or not said intrinsics function definition and said instruction attribute information is defined.

3. The compiler according to claim 1, wherein said intrinsics function definition includes a dummy argument type and identification name.

4. A compiler for generating object code from an input source code program, comprising:
a character string interpreter which divides instructions coded within an input source program into tokens;
a syntax analyzer, which analyzes syntax of said tokens;
an intrinsics function information database into which a definition of an intrinsics function and instruction attribute information characterizing an instruction coded by the intrinsics function are stored as intrinsics function information; and
a code generator which develops an instruction that calls an intrinsics function within said source program by referring to said intrinsics function information, and which converts said developed program either to machine language or to an intermediate code.

5. The compiler according to claim 4, wherein said syntax analyzer distinguishes a prescribed identifier indicating an intrinsics function from among a function declaration part coded within an external file, thereby making a judgment as to whether or not an intrinsics function definition and said instruction attribute information are defined.

6. The compiler according to claim 4, wherein said intrinsics function definition includes a dummy argument type and identification name.

7. A compiler for generating object code from an input source program, comprising:
a character string interpreter which divides instructions coded within an input source program into tokens;
a syntax analyzer which analyzes syntax of said tokens;
an intrinsics function information database into which a definition of an intrinsics function and instruction attribute information characterizing an instruction coded by the intrinsics function are stored as intrinsics function information; and
a code generator which develops an instruction that calls an intrinsics function within said source program by referring to said intrinsics function information, and which converts said expanded source program either to machine language or to intermediate code,
wherein said intrinsics function information includes a function declaration statement, to which is added a prescribed identifier indicating an intrinsics function, dummy argument information, and said instruction attribute information.

8. A method for compiling which generates object code from an input source program, comprising:
storing a definition of an intrinsics function into an intrinsics function information database;
storing instruction attribute information characterizing an instruction coded by an intrinsics function into said intrinsics function information database;
dividing instructions coded within an input source program into tokens;
analyzing the tokens and detecting from a combination of said tokens a declaration of a start of coding with regard to said intrinsics function; and
developing an instruction that calls an intrinsics function within said source program by referring to said intrinsics function information database, and converting said developed source program either to machine language or to intermediate code.

9. A method for compiling, which generates object code from an input source program, comprising:
dividing instructions coded within an input source program into tokens;
analyzing said tokens and detecting from a combination of said tokens a declaration of a start of coding with regard to said intrinsics function;
accessing an intrinsics function information database, into which are stored a definition of an intrinsics function and instruction attribute information characterizing an instruction coded by said intrinsics function;
developing an instruction that calls an intrinsics function within said source program; and
converting said developed source program either to machine language or to intermediate code.

10. The method for compiling according to claim 8, wherein said detecting of said declaration is performed by distinguishing a prescribed identifier indicating an intrinsics function from among a function declaration part of said source program, thereby making a judgment as to whether or not said intrinsics function definition and said instruction attribute information are defined.

11. The method for compiling according to claim 9, wherein said detecting of said declaration is performed by distinguishing a prescribed identifier indicating an intrinsics function from among a function declaration part of said source program, thereby making a judgment as to whether or not said intrinsics function definition and said instruction attribute information are defined.

12. A computer-readable recording medium onto which is stored a program causing a computer to execute compiling processing that generates object code from an input source program, said program comprising:
processing for character string interpretation, so as to divide instructions coded within an input source program into tokens;
processing for analyzing said tokens and for analyzing a syntax thereof to judge whether or not a combination of said tokens has a definition of an intrinsics function and instruction attribute information characterizing an instruction coded by said intrinsics function;
processing for storing a definition of said intrinsics function and said instruction attribute information as intrinsics function information;
processing for developing an instruction that calls said intrinsics function within said source program by referring to said intrinsics function information; and
generating code that converts said expanded source program either to machine language or to intermediate code.

13. The recording medium according to claim 12, wherein said syntax analysis processing distinguishes a prescribed identifier indicating an intrinsics function from among a function declaration part of said source program, thereby making a judgment as to whether or not said intrinsics function definition and said instruction attribute information are defined.

14. A computer-readable recording medium onto which is stored a program causing a computer to execute compiling processing that generates object code from an input source program, the program comprising:
processing for character string interpretation, so as to divide instructions coded within an input source program into tokens;
processing for analyzing syntax, so as to analyze the tokens;
processing for storing a definition of an intrinsics function and instruction attribute information characterizing an instruction coded by said intrinsics function as intrinsics function information;
processing for developing an instruction that calls an intrinsics function within said source program by referring to said intrinsics function information; and
generating code that converts said developed source program either to machine language or to intermediate code.

15. The recording medium according to claim 14, wherein said syntax analysis processing distinguishes a prescribed identifier indicating an intrinsics function from among a function declaration part of said source program, thereby making a judgment as to whether or not said intrinsics function definition and said instruction attribute information are defined.

16. A computer-readable recording medium onto which is stored a program causing a computer to execute compiling processing that generates object code from an input source program, said program comprising:
processing for character string interpretation, so as to divide instructions coded within an input program into tokens;
processing for analyzing syntax, so as to analyze said tokens;
processing for storing a definition of an intrinsics function and instruction attribute information characterizing an instruction coded by said intrinsics function as intrinsics function information; and
processing for accessing said intrinsics function information;
processing for developing an instruction that calls an intrinsics function within said source program by referring to said intrinsics function information; and
processing for generating code that converts the thus developed source program either to machine language or to intermediate code,
wherein said intrinsics function information comprises a function declaration statement to which is added a prescribed identifier indicating an intrinsics function, dummy argument information, and said instruction attribute information.

17. A program for causing a computer to execute compiling processing that generates object code from an input source program, said program comprising:
processing for character string interpretation so as to divide instructions coded within an input source program into tokens;
processing for analyzing said tokens, and performing syntax analysis so as to judge whether or not a combination of the tokens has an intrinsics function definition and a definition of instruction attribute information characterizing an instruction coded by said intrinsics function;
processing for storing said intrinsics function definition and intrinsics function information as intrinsics function information;
processing for developing an instruction that calls an intrinsics function within said source program by referring to said intrinsics function information; and
processing for generating code that converts said developed source program either to machine language or to intermediate code.

18. The program according to claim 17, wherein said syntax analysis processing distinguishes a prescribed identifier that indicates an intrinsics function from among a function declaration part of said source program, thereby making a judgment as to whether or not said intrinsics function definition and said instruction attribute information are defined.

19. A program for causing a computer to execute compiling processing that generates object code from an input source program, said program comprising:
processing for character string interpretation so as to divide instructions coded within an input source program into tokens;
processing for analyzing the syntax of said tokens;
processing for storing an intrinsics function definition and attribute information characterizing an instruction coded by said intrinsics function as intrinsics function information;
processing for accessing said intrinsics function information;
processing for developing an instruction that calls an intrinsics function within said source program by referring to said intrinsics function information; and
processing for generating code that converts said developed source program either to machine language or to intermediate code.

20. A program for causing a computer to execute compiling processing that generates object code from an input source program, said program comprising:
processing for character string interpretation so as to divide instructions coded within a source program into tokens;
processing for analyzing the syntax of said tokens;
processing for storing an intrinsics function definition and attribute information characterizing an instruction coded by said intrinsics function as intrinsics function information;
processing for accessing said intrinsics function information;
processing for developing an instruction that calls an intrinsics function within said source program by referring to said intrinsics function information; and
processing for generating code that converts said developed source program either to machine language or to intermediate code,
wherein said intrinsics function information is made up of a function declaration statement to which is added a prescribed identifier indicating an intrinsics function, dummy argument information, and said instruction attribute information.
